(19) United States
(12) Patent Application Publication
(10) Pub. No.: US 2011/0119196 A1
(43) Pub. Date: May 19, 2011

(54) CONFEDERATED KNOWLEDGE FOR TWO OR MORE INTERNET-ACCESSIBLE KNOWLEDGE MANAGEMENT SYSTEMS

(75) Inventors: Diego Ventura, Milpitas, CA (US); Felice Curcelli, Saratoga, CA (US)

(73) Assignee: NOHOLD, INC., Milpitas, CA (US)

(21) Appl. No.: 12/786,688

(22) Filed: May 25, 2010

Related U.S. Application Data
(60) Provisional application No. 61/262,437, filed on Nov. 18, 2009.

(51) Int. Cl. G06F 17/20; G06N 5/02; G06Q 10/00

(52) U.S. Cl. 705/304; 706/10; 706/47; 706/11

(57) ABSTRACT

In an automated method system for coordinating navigations within two or more knowledge bases that would otherwise be functionally independent, context-continuity is maintained when an automated transfer is executed from a first knowledge base to a second knowledge base. The transfer is triggered by detection that the second knowledge base has a greater relevance to the user. As a result of the context-continuity, information acquired prior to the transfer is used to achieve a partial navigation within the second knowledge base. For embodiments involving Virtual Agents, the content-continuity includes simulating a continuation of dialog despite the transfer.

### CROSS-REFERENCE TO RELATED APPLICATION

This application claims priority from U.S. Provisional Patent Application Ser. No. 61/262,437, entitled “CONFEDERATED KNOWLEDGE FOR TWO OR MORE INTERNET-ACCESSIBLE KNOWLEDGE MANAGEMENT SYSTEMS”, filed Nov. 18, 2009.

### TECHNICAL FIELD

The invention relates to expert systems for providing information to users, such as Virtual Agents.

### BACKGROUND ART

The traditional approach to providing technical support for users having problems or questions regarding a product (such as a computer or modem) or service (such as banking services) is to provide direct communication between the user and a technical “expert” regarding the product or service. However, automated systems are also available, such as described in U.S. Pat. No. 6,604,141 to Ventura. The Ventura patent describes a product support tool that interacts with a user who needs assistance, and the interaction occurs without requiring an actual person with expertise to control the interaction. Instead, a “Virtual Agent” is used to enable interactions between end users at remote computers and an expert system that utilizes a knowledge base having data relevant to diagnosing operating conditions of a product or service.

Virtual Agents may be used for purposes other than providing technical support to end users. For example, Virtual Agents may be used to automate interactions with human resources or other employee services of a company, in addition to providing a sales and/or marketing advisor for incoming calls to the company. However, in this patent document Virtual Agents will be considered primarily with respect to technical support applications.

As used herein, a “Virtual Agent” is a Web-based application that is designed to interact with the end users and guide them to a solution through a diagnostic process that does not require human intervention. As described in the Ventura et al. patent, the Virtual Agent preferably includes exchanges of information in a conversational format, i.e., a format that simulates dialog. The Virtual Agent is part of a system that includes a stored knowledge base having data relevant to diagnosing operating conditions of at least one product or service. The knowledge base may define a tree arrangement of rules in which each rule includes a solution and at least one related antecedent that represents the operating condition of the product or service and indicating the appropriateness of the solution. Free-form descriptions of operating conditions of the product or service are provided by the end user. The system attempts to accumulate “known facts” that are either directly entered by the user or that are acquired using system induction or system deduction from the communications with the end user. FIG. 1 represents a sequence of exchanges between a Virtual Agent (“CT”) and an end user (“Guest”). As can be seen, the Virtual Agent interacts with the end user in the same manner as would an actual person, including generating confirmation statements so as to confirm “known facts.” These known facts are used to determine a solution.

A limitation with use of a Virtual Agent is identical to the limitation of using real person experts for providing technical support for a product or service. Specifically, the knowledge base of the system and the knowledge of the person are typically limited to the single product or service. If during interaction with the end user, it is determined that a different product is responsible for the difficulty experienced by the user, the individual must terminate the first technical support interaction and start again with a different Virtual Agent or technical support person. For example, if an individual purchases a replacement computer from Acer, Inc., but continues to use the same Linksys wireless router for Internet connectivity, the person is likely to assume that the replacement computer is at fault if Internet connectivity is no longer available. Thus, the individual may use a separate computer to access the Web-based Virtual Agent that is specific to the Acer computer, only to discover that the knowledge base of the Acer Virtual Agent is not designed to aide people with Internet connectivity problems. FIG. 2 represents a brief interaction with the Acer Virtual Agent before its only stored solution is presented. In practice, the interaction may be much more involved. The presentation of a single solution is by design, since the Acer Virtual Agent was created primarily to answer questions regarding Acer products. The sole solution describes a few steps to verify that the wireless card within the computer is operable. This Virtual Agent preferably makes it clear that Acer is not designed to configure the network to which the computer is linked. The next step would be for the individual to disconnect from the Acer Virtual Agent and instead establish a connection to the Linksys Virtual Agent with its wider range of solutions for connectivity problems.

While the use of Virtual Agents and similar automated technical support systems operate well for their intended purpose, advancements are sought. Such advancements are also sought in other applications of Virtual. Agents.

### SUMMARY OF THE INVENTION

The invention is a method of coordinating navigations within two or more knowledge bases that would otherwise be functionally independent. Each of the knowledge bases is a structured arrangement of rules related to specific subject matter, and the navigations within the knowledge base are executed in an automated manner. In one embodiment, each knowledge base is an expert system implemented as a Virtual Agent. While the subject matter of one knowledge base may have some overlap with the subject matter of the other knowledge base, the overlap is not major. For example, the first knowledge base may be designed for providing technical support for a commercially available product of a first business entity and a second knowledge base may be designed for providing technical support for a commercially available product of a second business entity that is independent of the first.

During a session with the first knowledge base (such as the knowledge base of a first Virtual Agent), it may be determined from user inputs that the subject matter of another knowledge base has a greater relevance to the user. As an automated response to such a determination, a transferring occurs from the first knowledge base to the second knowledge base, but the transfer is executed with context-continuity. That is, information acquired prior to the transfer is used to achieve a partial navigation within the structured arrangement of rules of the second knowledge base. For embodiments in which sessions are conducted in a conversational format, the context-continuity includes simulating a continuation of dialog despite the transfer. This simulation of a continuing dialog is particularly relevant to embodiments in which the knowledge bases are components of different Virtual Agents,

The structured arrangement of rules may be a tree-like structure. An end-user at a remote computer may be transferred among Virtual Agents without contextual loss.

The first promising application of the invention is one in which Virtual Agents or other automated knowledge management systems (“expert systems”) are designed for products of companies which are independent business entities. The products may be operationally linked, but the product providers are not. An example would be an Acer laptop computer and a Linksys router. This application of the invention is particularly well suited for situations in which the two Virtual Agents are designed by the same third-party company, such as noHold, Inc., but the invention may be used in other cooperative situations. A second application is one in which a single company provides a number of different products, but the company has decided to utilize independent Virtual Agents which specialize in their respective products. The benefits of such a specialization are that a more thorough knowledge base is likely for each product and that the technical support capability of the company is easily adapted if a particular product is discontinued or upgraded.

Confederated Knowledge links may be used to implement the invention. As used herein, a “Confederated Knowledge link” is a connection that allows in-place activation of a second knowledge base from within a first knowledge base. The first knowledge base may be considered to be the “Host,” while the second knowledge base may be considered to be the “Partner”. As a session takes place with the Host knowledge base, the determination that the Partner has the more relevant knowledge base triggers activation of the Partner but from within the Host. This “in-place activation” is distinguishable from conventional approaches, as is the “context retention” of acquired information when the transfer is made from the Host to the Partner.

There are at least four procedural embodiments for switching between Virtual Agents. For purposes of explanation, the embodiments will be described with respect to the “knowledge trees” and “known facts” set forth in the above-identified Ventura patent. In a first embodiment, the known facts that were acquired during interaction with the first Virtual Agent are used to identify the appropriate position on the knowledge tree of the second Virtual Agent. The potential weakness of this first embodiment is that if the second knowledge tree is not static, the pointer of the first knowledge tree may become obsolete. It should be noted that the pointer does not become obsolete if the target location (e.g., an antecedent node) of the second knowledge tree is merely moved as a result of a modification of the second knowledge tree. A movement of the antecedent node does not render the pointer invalid. It should also be noted that there are possible solutions to the potential weakness. For example, rather than a “static pointer” as the connection between the two knowledge trees, a loose connection may be made “behind the scenes”, such as by posing a user question to the second knowledge tree in a manner transparent to the user but that solicits a response which either automatically establishes the appropriate location of the second knowledge tree or presents a confirming question to the user.

In the second embodiment, the known facts that were accumulated in navigation of the first Virtual Agent's knowledge tree are in effect carried to the base of the second Virtual Agent's knowledge tree and then used to navigate through the knowledge tree until an additional fact is needed at a particular node. This navigation is transparent to the end-user, with the conversational format continuing from this node. The third embodiment is the same as the second embodiment, but the previously acquired known facts are applied to nodes which follow the one at which an additional fact is required, so as to determine whether a reliable deduction can be made as to further navigation without requesting an additional fact from the end-user. Thus, the first embodiment provides context-continuity (since the transfer appears to be “seamless” to the user), while this third embodiment provides both context-continuity and content retention beyond the transfer to the particular node at the second knowledge base. The fourth embodiment is also the same as the second embodiment, but the known facts acquired during navigation of the first knowledge tree continue to be referenced after the additional fact is required at the stopping node, so that subsequent nodes within the second knowledge tree can be skipped when the known facts provide the required information (again, content retention). That is, a known fact that may not have been useful in the original navigation within the second knowledge base remains accessible for possible use following subsequent inputs from the end-user. At what may be considered a fifth, most sophisticated embodiment, the post-transfer use of known facts as described in the third and fourth embodiments are combined.

### BRIEF DESCRIPTION OF THE DRAWINGS

FIG. 1 is a sample conversational format with a Virtual Agent which is one possible embodiment of a knowledge base which may be adapted for implementation of the present invention.

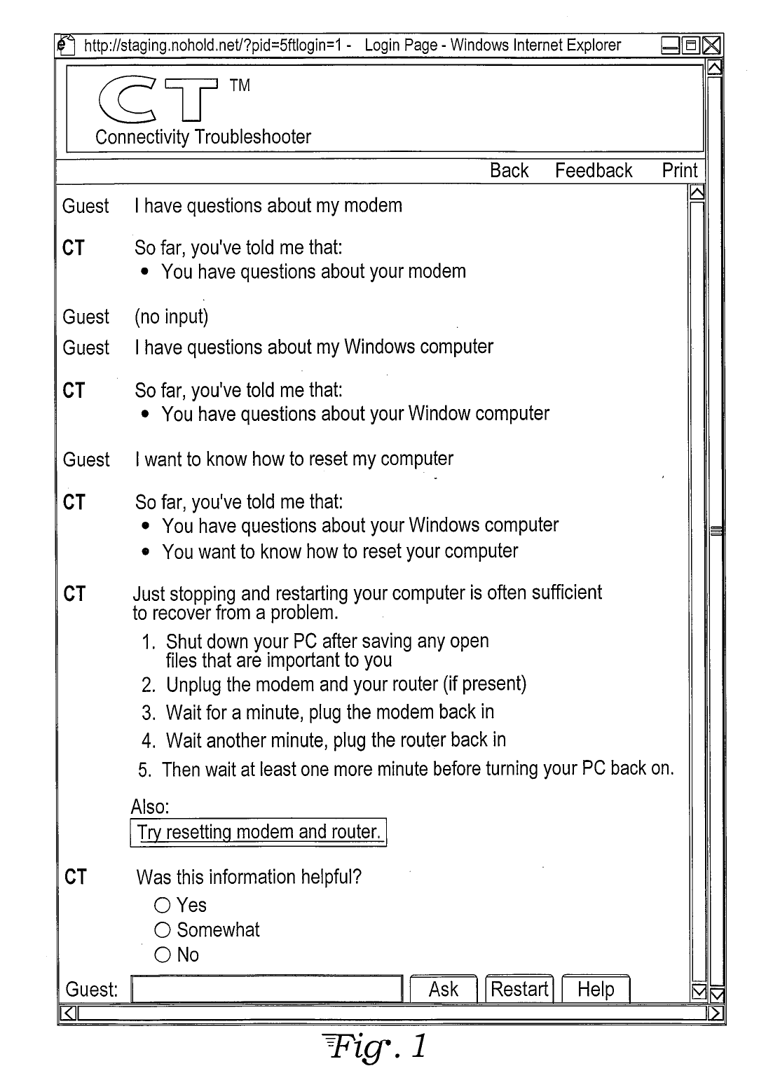

FIG. 2 is another Web-based conversation with a Virtual Agent.

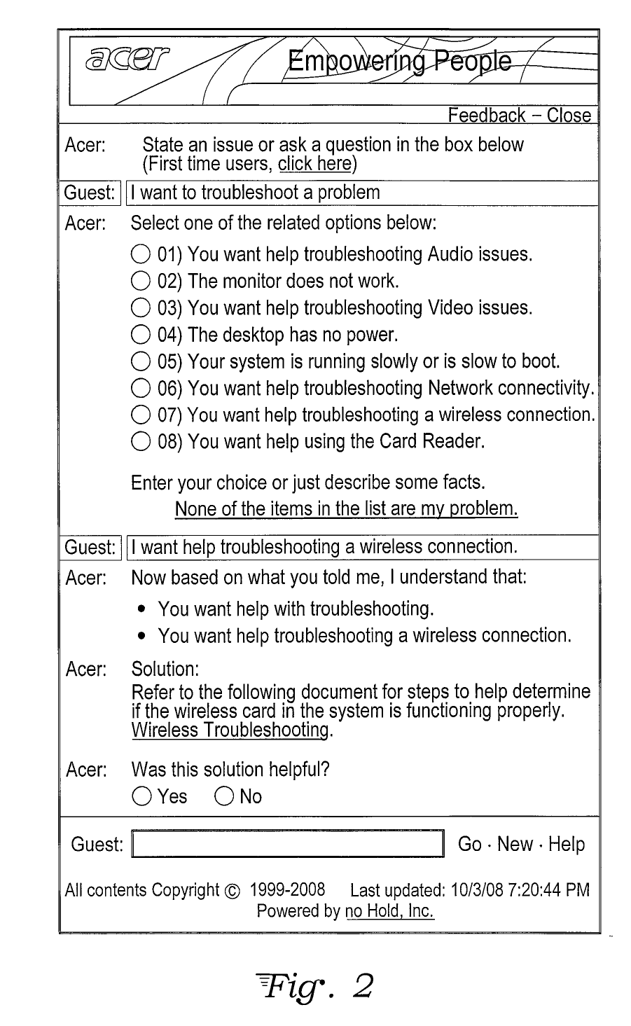

FIG. 3 is a block diagram of components of a network connectivity of a pair of Virtual Agents with confederated knowledge links in accordance with one embodiment of the invention.

FIG. 4 is a block diagram of the components of one embodiment of the expert system of FIG. 3

FIG. 5 is a process flow of steps that are implemented during a session using the components of FIGS. 3 and 4.

FIG. 6 is an example of in-place activation of a Partner Virtual Agent from a Host Virtual Agent in accordance with the invention.

### DETAILED DESCRIPTION

As described above, the invention allows transfers between expert systems which enable automated navigation through knowledge bases. The transfers will be described primarily with respect to Virtual Agents which are consistent with the teachings of the Ventura patent (U.S. Pat. No. 6,604,141), but other embodiments are available. Each such Virtual Agent includes an expert system that may be formed as a combination of computer hardware and software.

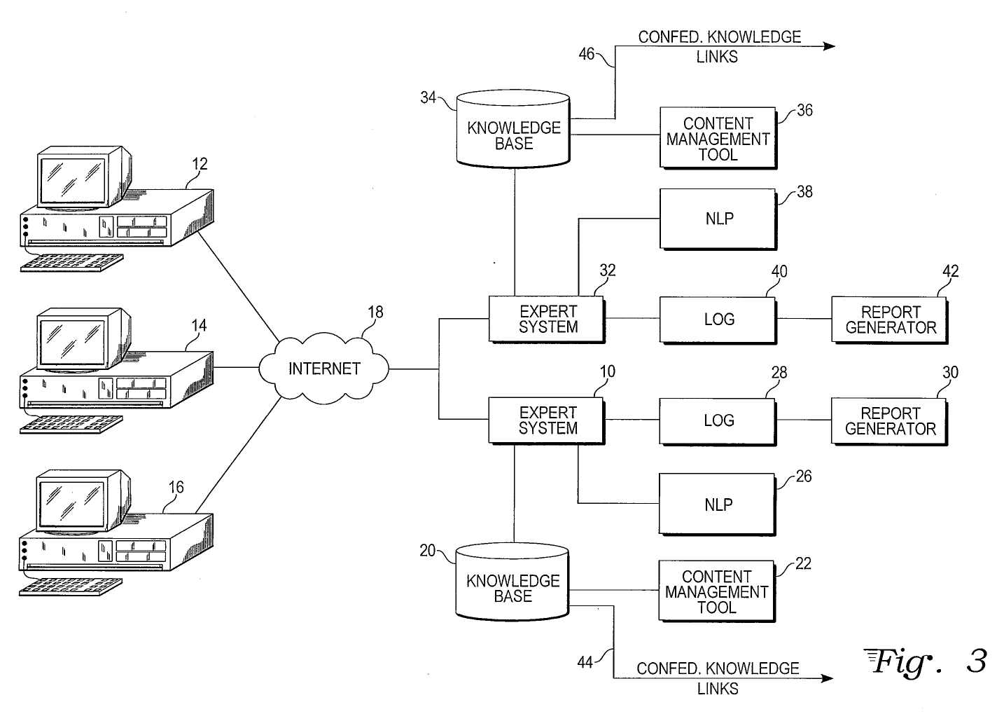

With reference to FIG. 3, two functionally independent Virtual Agents 10 and 32 are shown as being accessible by remote computers 12, 14 and 16 via the global communications network commonly referred to as the Internet 18. Each Virtual Agent may be designed to provide technical support for one or more products, such as a particular automobile, computer or computer periphery. As one example, the Virtual Agent 10 may be dedicated to technical support for a particular computer manufacturer, while the Virtual Agent 32 is dedicated to technical support for modems sold by a different manufacturer. As another example, the Virtual Agents may be dedicated to two independent concerns for employees within a single corporation, such as distinct HR (human resources) concerns. As will be described more fully below, the sessions between one of the Virtual Agents and one of the remote computers are conducted in a “conversational format”, i.e., a format that simulates dialog). The Internet connectivity preferably is via the World Wide Web (WWW), with the Virtual Agents being stored at one or more WWW servers having a specified Universal Resource Location (URL).

Each Virtual Agent 10 and 32 (or other embodiment of an expert system) can be “trained” to be an expert on any product or group of products merely by forming and storing a knowledge base 20 and 34 that is specific to the product or product group. The knowledge base is shown in FIG. 3 as being separate from its respective Virtual Agent, but the “knowledge base” can be considered as being synonymous with the term “expert system” with respect to some embodiments of the invention. The knowledge base is a component that contains rules about the product. The rules include antecedents and solutions. For example, if the first Virtual Agent 10 is used to provide technical support for a car of a particular make, the knowledge base 20 will include the rules regarding the operations and characteristics of the car. On the other hand, the second Virtual Agent 32 may involve support of a service, such as providing pre-sales service for a financial institution (e.g., a financial institution for the sale of the cars supported by the first expert system). In such an application, the knowledge base 34 contains information about the operations and services provided by a bank or similar institution.

A Content Management Tool 22 or 36 is employed to create its respective knowledge base 20 or 34. Using the Content Management Tool 22, a technical support engineer may form a tree-like structure of rules in which each rule preferably includes multiple antecedents. The Virtual Agent 10 then implements a heuristic approach to problem solving. The approach is goal oriented, so that after a user of the product submits a description at one of the remote computers 12, 14, and 16, the Virtual Agent attempts to suggest a solution. If the initial description does not provide sufficient information, confirming question text strings are generated and transmitted to the remote computer of the user. The hunt for a solution is based upon the information originally entered by the user during the description of the problem and upon the information entered by the user in response to the confirming question text strings from the Virtual Agent. Deduction allows the expert system to reach a general truth (solution) from details provided by the user. Induction allows the expert system to provide a solution based upon confirmation of detailed facts. The same approach is implemented in the other of the two Virtual Agents 32. However, the “knowledge base-to-knowledge base transfers” in accordance with the present invention may be executed in embodiments in which the Virtual Agents utilize other approaches to internally process information acquired from a user at one of the remote computers.

Because the Virtual Agents 10 and 32 are accessible via the Internet 18, multiple connections can be conducted simultaneously. Ideally, neither Virtual Agent imposes any limitation on the number of concurrent sessions it can support. Rather, the number of connections is limited by the resources of the WEB server on which the system is running. Another advantage of the connectivity via the Internet is that each Virtual Agent is available on a twenty-four hour a day basis. If a user of a product for which technical support is provided has a browser application that provides access via the WWW, the user is able to contact the Virtual Agent 10 at any time.

Preferably, each expert Virtual Agent 10 and 32 and its knowledge base 20 and 34 are cooperative to enable the generation of confirming question text strings in a number of alternative forms. That is, while the content of a confirming question may be determined by the cooperation of the Virtual Agent and the knowledge base, the phrasing of the content of confirming questions may be determined by a Natural Language Processing (NLP) component 26 and 38, which among other operations may randomize the preambles of the confirming questions. The NLP is shown as a separate component, and is typically carried out in computer software. A knowledge specialist uses the Content management Tool 22 and 36 to define a number of alternative preambles of the confirming question. During sessions, the NLP constructs the confirming question based on the available preambles and the antecedent in the knowledge tree. This enhances the simulation of human conversation when a user at one of the remote computers 12, 14, and 16 engages in a technical support session.

The components of each Virtual Agent 10 and 32 also include a session log component 28 and 40 that maintains logs of each session involving its interactions with users at remote computers. A report generator 30 and 42 is used to derive statistical analysis from the logs. For example, the generator 30 may report statistics about the number of sessions in which the Virtual Agent 10 was able to provide a solution to a problem. This information can then be used as a retrofit to the system, thereby rendering the system “smarter.” Moreover, in some embodiments, the knowledge base 20 and the report generator 30 may be cooperative to create other types of database reports. For example, a system engineer may simply input, “Prepare a sales report for Q2-2010,” triggering the system to proceed with a command sequence to prepare the requested database information.

During a session, free-form description is provided by the user who seeks technical support for a particular product. The NLP 26 determines through keyword matching and similarity algorithms which antecedents are potentially relevant.

Furthermore, the NLP 26 uses the confirming question preambles to randomly form confirming questions thus making the system appear to be more human-like.

Moreover, the meaning of a confirming question string that is transmitted to a user remains the same, regardless of the format. The first time that a question is presented, the question may be phrased as, “Is it correct that the battery has been charged?” and the second occurrence may be phrased as, “Do you mean that the battery has been charged?”.

Each Virtual Agent 10 and 32 may have its own URL, so that a session with the appropriate Virtual Agent is triggered when a user enters the URL into a browser application. Users visiting the WEB site can interact with the Virtual Agent via the Internet 18, as indicated in FIG. 3. Technical support is available for specific goods or services. In a text string that is transmitted from the remote computer 12 of the user to the Virtual Agent, the user identifies the make and model of the product. The Virtual Agent can then generate and transmit a request string for additional information. When the user responds with “Where can I find support?”, the Virtual Agent is able to identify options.

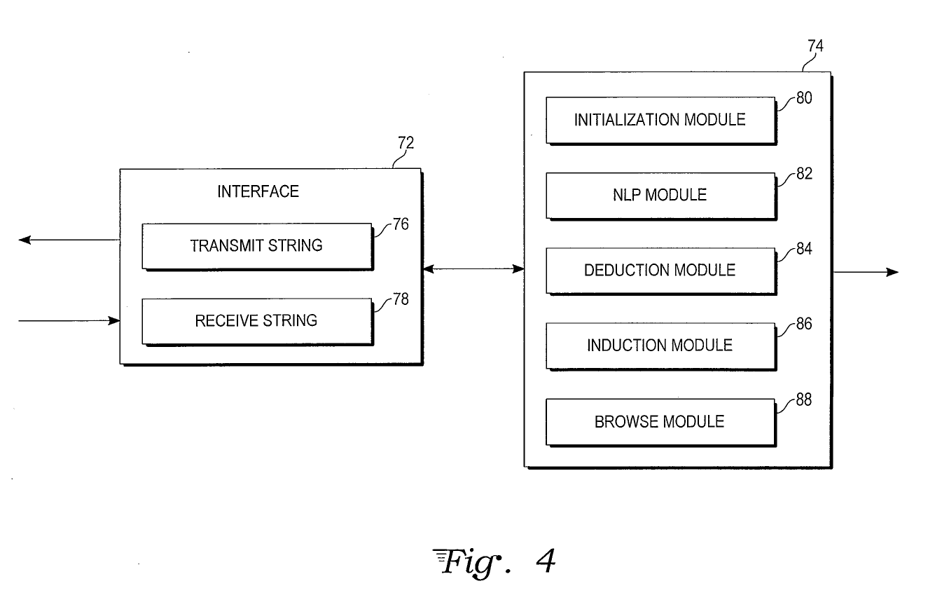

The user may enter and transmit a text line that is a free-form description of the problem. By “free-form,” what is meant is that the user is not restricted to any sentence form or any dictated vocabulary. The Virtual Agent then applies NLP processing to identify an appropriate antecedent, i.e., fact that applies to the free-form description of the problem. As will be explained when referring to FIG. 4, the system uses deduction and induction of known facts to confirm antecedents. One approach is for the system to phrase the question as a request for confirmation of a deduction reached by the Virtual Agent 10 and 32 from the user inputs. If the confirmation is received, the system may request additional information, or return a solution with continuation options, i.e., to allow user to express if solution solved the problem, or if other similar solutions should be shown, or to start over and let Virtual Agent drive the interaction, or stop the interaction altogether and transfer control to an external system, e.g., to a live representative.

Referring now to FIG. 4, components of the Virtual Agent 10 of FIG. 3 are shown. The second Virtual Agent 32 may have the same components, so only one Virtual Agent will be described. The components include a user interface 72 and a knowledge base interface 74.

The two interfaces are preferably carried out in computer software, and are the two main threads of execution of the Virtual Agent. The user interface 72 is responsible for communication with the users seeking technical support. The knowledge base interface 74 is responsible for implementing the deduction and induction algorithms that link information from the users with rules within the knowledge base.

Within the user interface 72, a transmit string module 76 sends the question strings, solution strings, and any information to the users via the Internet. In a reverse direction, a receive string module 78 accepts transmissions from the users. Both the transmitted strings and the received strings are in a format compatible with transmission over the Internet. For example, HTML (Hyper Text Markup Language) templates or CGI (Common Gateway Interface) scripts may be used. Techniques for implementing the user interface 72 are known in the art.

The knowledge base interface 74 includes an initialization module 80. This module is responsible for opening data files and creating a representation of the knowledge base in memory. While not critical, a dynamic doubly linked list may be used. The module uses the user interface 72 to notify a user that he or she can start describing the problem.

An NPL module 82 interacts with the user via the user interface 72 and allows the user to enter as many facts as desired. The module attempts to match the facts with the antecedents in the knowledge base. If it is successful, the antecedent is verified as a “known fact.” A deduction module 84 is responsible for applying a forward chaining algorithm on the “known facts” that are entered by the user. To accomplish this, the algorithm parses the knowledge base and attempts to confirm any of the rules that include these known facts as antecedents. If a rule is confirmed, the conclusion stored as part of the rule is presented to the user as the solution to the identified problem.

The induction module 86 is utilized if the conclusion is not reached by means of the deduction module 84. The induction module applies a backward chaining algorithm on the “known facts.” In this case, the Virtual Agent attempts to confirm rules that have at least one confirmed antecedent, which means that the rule already contains a known fact. For example, if the Virtual Agent has invoked the NPL module 82 to identify a rule in which two of the three antecedents have already been verified, the Virtual Agent will request that the user confirm the existence of the third antecedent of the rule. If the user provides confirmation in response to a confirming question string, the Virtual Agent tags the rule as having one solution. The Virtual Agent may take advantage of additional information that the user may offer when the user is answering a question string. For example, if the Virtual Agent transmits a question string that asks “Is the battery charged?” but the user answers, “I don't know, but the fuses are OK,” the Virtual Agent enters this new fact in the known facts. The deduction module 84 is then used to reapply the forward chaining algorithm, just in case the new piece of information identifies a new rule.

A Browse module 88 is generally needed when the NPL module 82 of the Virtual Agent cannot associate anything in the knowledge base with anything described by the user. To avoid a session in which the Virtual Agent sends a large number of questions that do not appear to be focused, the Virtual Agent may take advantage of the tree-like structure of the knowledge base and proceed by category. The questions become more specific when the user confirms interest in a certain category of the tree-like structure of the knowledge base.

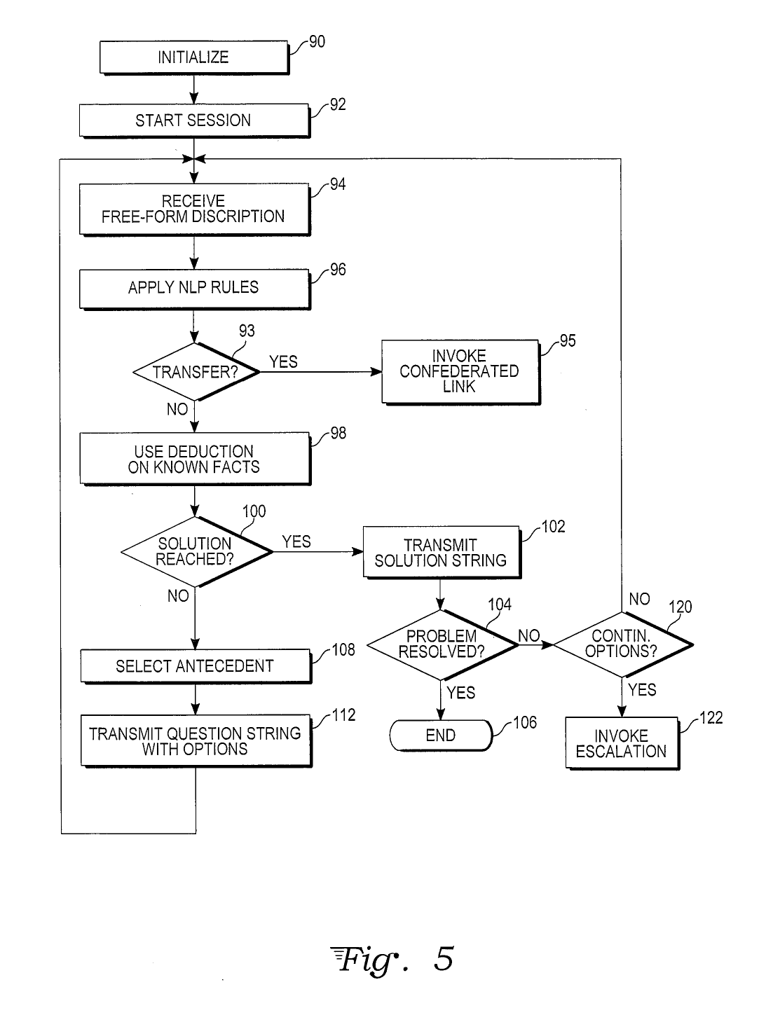

FIG. 5 is one'possible embodiment of an automated session that uses a conversational format (dialog simulation) and that enables context-continuity upon a transfer from a first knowledge base to a second knowledge base. However, the context-continuity transfers may also be implemented in environments that do not include exchanges in a conversational format. It is at decision step 93 that a determination is made as to whether a transfer to another Virtual Agent (or other type of knowledge base) would be beneficial to the person involved in a particular session. For a typical session, this decision step is encountered repeatedly, since the process includes a loop. With each such encounter, the advantages of context-continuity for a transfer between Virtual Agents increase, since the person will not be required to re-enter descriptions after a transfer is executed. The position of decision step 93 may be different in other embodiments (e.g., following step 96 or step 98). As another possibility, the process can include a number of these decision steps, where a positive response to any one of them will trigger a transfer.

At step 90, the initialization module 80 of FIG. 4 creates a representation of the knowledge base in memory. In step 92, the session with a particular user begins. In a Web-based application of the process, the session initialization and start may occur when the user enters the proper URL into a browser application and allows the website to load. The user enters a free-form description of the problem that is to be resolved, as indicated at step 94. The content of the description provides a basis for NPL processing and for using deduction on known facts, in steps 96 and 98. As previously noted, the deduction on known facts is accomplished by applying the forward chaining algorithm on the known facts entered by the user.

In decision step 100, it is determined whether the deduction step 98 verified a particular rule of the knowledge base. If so, the solution that is contained within the rule is transmitted in a solution string at step 102. The solution string provides the information that is indicated as being the resolution to the problem faced by the user. In the optional step 104, the process may include determining whether the problem has been resolved. This is typically performed by transmitting continuation options to the user, as indicated at step 120. If the problem is resolved using the solution from the rule, the process ends at step 106. On the other hand, if the suggested solution does not resolve the problem, a question is selected at step 108. Similarly, if no solution was determined to have been reached at step 100, the process proceeds to step 108. A backward chaining algorithm may be used in step 108 to select a one or more antecedent. Each antecedent may be selected based on induction on known facts. Then, in step 112, a question string is transmitted, along with options available to the user.

Alternatively, when at decision step 104, the options that are identified to the user in step 112 include allowing the user to designate the Virtual Agent as the driving force of the conversational flow. This is represented by the “invoke escalation” step 122. Other available options include allowing a user to browse the knowledge base manually and allowing the user to request intervention by a company representative.

While the automated process has been described with respect to the transmission of text files to the users at the remote computers 12, 14, and 16 of FIG. 3, this is not critical. Alternatively, the “text strings” to the users may be audio files that are selected using automated processing and are then transmitted via the Internet 18 for audibilization at the remote computers. As another alternative, the messages may be combinations of audio and text files.

Following execution of the transmission step 112 or 120, the processing returns to step 94. This will repeat until an affirmative response occurs at either the “Problem Resolved?” step 104 or the “Transfer?” step 93. In the embodiment of FIG. 5, a transfer invokes a Confederated Knowledge link, as indicated by step 95. This link allows the transfer to a “non-start position” within the knowledge base to which the transfer is made, while the session continues in a manner that appears seamless to the user at the remote computer.

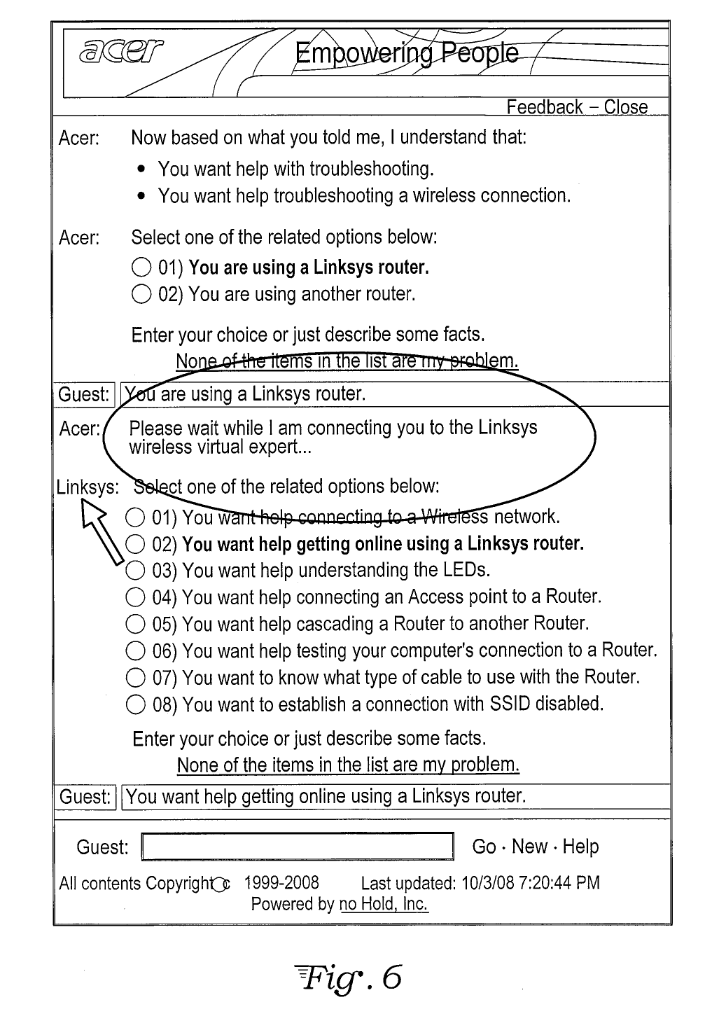

A significant difference between the present invention and previous expert systems (such as prior Virtual Agents) is that the “known facts” acquired during interaction with a first Virtual Agent are used to determine a “non-start position” if the end-user is switched to a second Virtual Agent (where the “start position” is defined as the initial exchanges that occur between the user and the system if the second Virtual Agent is originally accessed by the user). This is referred to as “context-continuity.” In the preferred embodiment, Confederated Knowledge links provide “in-place activation.” This is illustrated in the browser application capture of FIG. 6. In one scenario, the end-user (“Guest”) contacts the Acer Virtual Agent via the appropriate Website. Following exchanges with the Acer Virtual Agent, the known facts include the understanding that Guest wants help with troubleshooting a wireless connection. Guest is presented with the option of “01) You are using a Linksys router.” This option regarding a particular router is significant, since the Linksys Virtual Agent is cooperative with the Acer Virtual Agent. For example, both Virtual Agents may be deployed by the same third-party provider, such as noHold, Inc. When Guest identifies the router as being a Linksys router, Guest is informed that the Linksys Virtual Agent is being introduced, as indicated by the oval that has been added to FIG. 6. Soon, the Linksys Virtual Agent drives the communications with Guest, as indicated by the arrow that has been added at the left side of FIG. 6.

In FIG. 6, the Acer Virtual Agent remains as the apparent Host, since it was originally contacted and its presence is still identified, even after the session is transferred to the Linksys Virtual Agent, which is the Partner. The Acer Virtual Agent may have a limited number of possible solutions for troubleshooting a wireless connection. On the other hand, the Linksys knowledge base may have more than 600 solutions pertinent to the issue. However, Guest is not required to start at the base of the Linksys Virtual Agent. Instead, the Linksys Virtual Agent is initiated to present options relevant to troubleshooting a wireless connection. Guest is not required to repeat previous inputs. Nevertheless, Guest is allowed to insert a free-form textual string within the input box at the bottom of FIG. 6.

All parties are able to benefit from the use of Confederated Knowledge. Guest is not required to be concerned with which Virtual Agent to contact. Instead, Guest can connect to the Acer technical support capability in order to find the solution, even if the problem is with a different product. The benefit to Acer is that the company is able to increase the scope of its automated determination of solutions without incurring the cost of creating and maintaining content that is not directly significant to its products. Moreover, the newly inherited content reduces out-of-scope escalations. The benefit to Linksys is that there is an opportunity to offer both an enhanced product to its business partners and an enhanced self-service program. Additionally, the Virtual Agent operates as a potential channel for additional revenue. When an Acer customer is considering purchase of a router, the customer is more likely to purchase one that is directly integrated into the support offering provided by Acer.

As previously noted, there are at least four embodiments for providing the seamless transfer between Virtual Agents or other types of expert systems. In the most sophisticated of the embodiments, a transfer (1) is “in-place” (the presence of the original expert system is at least seemingly retained), (2) is implemented with context-continuity, and (3) allows “content retention (the known facts from the first expert system are available for use by the second, even after the initial automated navigation within the second expert system has been completed and interactions between the second expert system and the user have begun). Moreover, although the invention has been described primarily with respect to providing technical support for products or services, other applications exist for linking otherwise independent knowledge bases. For example, databases relating to product sales may be linked, as can knowledge bases relating to HR (Human Resources) for employees of a business entity.

What is claimed is:

1. In a computer system, a method of coordinating automated navigations of a plurality of functionally independent knowledge bases in which each knowledge base is a structural arrangement of rules related to specific subject matter, each of the automated navigations being based upon user inputs, the method comprising:
detecting occurrences in which the user inputs that are received during sessions of the automated navigations within a first knowledge base are indicative of an increased relevance to the specific subject matter to which a second knowledge base is directed; and
as an automated response to detecting each said occurrence, transferring the session from the automated navigation within the first knowledge base to automated navigation within the second knowledge base, including utilizing the user inputs received in the automated navigation within the first knowledge base to implement partial navigation within the second knowledge base, thereby providing context-continuity in the transferring.

2. The method of claim 1 wherein the user inputs include incoming text strings of free-form descriptions, the automated navigations including selecting outgoing text strings based on the incoming text strings.

3. The method of claim 2 wherein the outgoing text strings are formatted for simulation of a dialog when considered in combination with the incoming text strings of a particular session, such that providing the context-continuity includes simulating a continuation of dialog despite the transferring of the session from automated navigation within the first knowledge base to automated navigation within the second knowledge base.

4. The method of claim 1 further comprising using federated knowledge links within the structured arrangement of rules of the first knowledge base including using the confederated knowledge links to define the partial navigation within the second knowledge base.

5. The method of claim 4 wherein using the federated knowledge links includes identifying particular locations within the second knowledge base, such that activation of one of the federated knowledge links initiates an in-place activation of the second knowledge base at the particular location identified by the federated knowledge link.

6. The method of claim 1 wherein transferring the session includes employing known facts identified in the automated navigation within the first knowledge base to identify a particular location within the second knowledge base, thereby implementing the partial navigation with context-continuity.

7. The method of claim 6 further comprising continuing to use the identified known facts for the automated navigation of the second knowledge base after the partial navigation to the particular location is implemented, such that the identified known facts may be utilized for further deductions within the session.

8. The method of claim 1 further comprising conducting the sessions by using a browser application and a simulation of a dialog, the transferring being implemented to simulate a continuation of an on-going dialog.

9. The method of claim 8 wherein conducting the sessions includes maintaining the browser application such that the first knowledge base remains as an apparent host both before and after the transferring of a particular session.

10. The method of claim 1 wherein said knowledge bases are specific to providing technical support, the knowledge bases being tree-like structures of rules for products of different business entities, such that the transferring includes changing from rules related to support of a first product of a first business entity to rules related to support of a second product of a second business entity.

11. In a computing system, a method of coordinating expert systems which are independent with respect to operability, the method comprising:
enabling network connectivity for network sessions for accessing a first expert system from remote computers, including enabling exchanges of text strings in a format which simulates conversational exchanges, the first expert system being specific to first subject matter and being configured to generate automated outgoing text messages to the remote computers;
enabling network connectivity for network sessions for accessing a second expert system from the remote computers, including enabling exchanges of text strings in the format which simulates conversational exchanges, the second expert system being specific to second subject matter and being configured to generate automated outgoing text messages to the remote computers; and
incorporating links within at least one of the first and second expert systems to execute a transfer to the other of the first and second expert systems upon recognition of a condition in which the other is more relevant to a particular network session, including executing the transfer so as to maintain a simulation of an on-going dialog within the particular network session.

12. The method of claim 11 further comprising implementing the first expert system to include a first knowledge tree and implementing the second expert system to include a functionally independent second knowledge tree, each of the links being configured to trigger a navigation from an intermediate position within the at least one of the first and second expert systems to an intermediate position within the other of the first and second expert systems.

13. The method of claim 11 wherein the network sessions support employing browsers at the remote computers in the exchanges of the text messages.

14. The method of claim 11 wherein enabling the exchanges of text messages includes enabling audibilization of the text messages at the remote computers.

15. The method of claim 11 wherein executing each transfer includes partially navigating a structured arrangement of rules of the other of the first and second expert systems, so as to reach a position within the structured arrangement on a basis of known facts that were identified during the particular network session prior to the transfer, thereby providing context-continuity within the particular network session.

16. The method of claim 15 including providing the partial navigation in a manner that is transparent to users at the remote computers.

17. The method of claim 11 wherein executing the transfer is a change of automated navigation from within the first expert system to automated navigation within the second expert system, the transfer being implemented such that communications to the remote computer involved in the particular network session establish an appearance of the first expert system remaining as a host to the particular network session.

18. The method of claim 17 wherein the first subject matter is specific to a first product of a first business entity and wherein the second subject matter is specific to a second product of a second business entity that is independent of the first business entity.
